(19) United States
(12) Patent Application Publication
(10) Pub. No.: US 2001/0023705 A1
(43) Pub. Date: Sep. 27, 2001

(54) Backflow valve for an end of a pipe

(76) Inventor: Gabe Coscarella, Edmonton (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/747,061

(22) Filed: Dec. 20, 2000

(30) Foreign Application Priority Data
Mar. 23, 2000 (CA) 2,302,455

(51) Int. Cl. F16K 15/00

(52) U.S. Cl. 137/269.5; 137/527.8; 137/448

(57) ABSTRACT

A backflow valve for an end of a pipe includes a cylindrical body having coupling at a first end which is adapted to mate with an end of a pipe. A closure gate is pivotally mounted to the second end of the body for movement about a substantially horizontal axis between an open position permitting flow in one direction through the flow passage and a closed position blocking the flow passage to prevent a reversal of flow.

### FIELD OF THE INVENTION

The present invention relates to a backflow valve which attaches to an end of a pipe.

### BACKGROUND OF THE INVENTION

A backflow valve, also known as a backwater valve, is used to prevent a reversal of flow in a flow line. An example of a backflow valve is disclosed in Canadian Patent 2,114,602 and corresponding U.S. Pat. 5,406,972 granted to Coscarella et al.

There are various applications in which a pipe discharges into a tank. For example, a house having a septic tank and a septic field will have a pipe extending from toilets in the house to the septic tank. In such applications, a backflow valve is placed on the discharge end of the pipe that discharges into the septic tank, in order to prevent a reversal of flow from the septic tank back into the house.

Periodically, septic tanks must be visually inspected. One of the points of inspection is the discharge end of the discharge pipe. Unfortunately, the position of the backflow valve obscures the discharge end of the pipe. This necessitates the person doing the inspection to enter the tank to perform the inspection.

### SUMMARY OF THE INVENTION

What is required is an alternative backflow valve configuration.

According to the present invention there is provided a backflow valve for an end of a pipe which includes a cylindrical body having a first end, a second end and a flow passage that extends between the first end and the second end. The first end is securable to an end of a pipe. A closure gate is pivotally mounted to the second end of the body for movement about a substantially horizontal axis between an open position permitting flow in one direction through the flow passage and a closed position blocking the flow passage to prevent a reversal of flow.

The backflow valve, as described above, is of simple construction. Its construction is such that a potential problem that appears to be adversely affecting the proper closing of the valve can be detected by a visual inspection made at a distance.

The above described backflow valve operates slightly differently depending upon the orientation during installation. When the closure gate is pivotally mounted to a top of the body, it normally assumes the closed position by force of gravity. The closure gate is then pivoted to the open position by the flow of liquid through the body. When the closure gate is pivotally mounted to a bottom of the body, it normally assumes the open position by force of gravity. The closure gate has a float. The rise of liquid in the tank into which the pipe discharges floats the closure gate into the closed position.

### BRIEF DESCRIPTION OF THE DRAWINGS

These and other features of the invention will become more apparent from the following description in which reference is made to the appended drawings, wherein:

FIG. 1 is a side elevation view, in section, of a first embodiment of a backflow valve constructed in accordance with the teachings of the present invention secured to a pipe with the horizontal pivot axis at the top of the body and the closure gate in the normally closed position.

FIG. 2 is a side elevation view, in section, of the backflow valve illustrated in FIG. 1, in the open position.

FIG. 3 is a side elevation view, in section, of a second embodiment of a backflow valve constructed in accordance with the teachings of the present invention secured to a pipe with the horizontal pivot axis at the bottom of the body and the closure gate in the normally open position.

FIG. 4 is a side elevation view, in section, of the backflow valve illustrated in FIG. 3, in the closed position.

### DETAILED DESCRIPTION OF THE PREFERRED EMBODIMENT

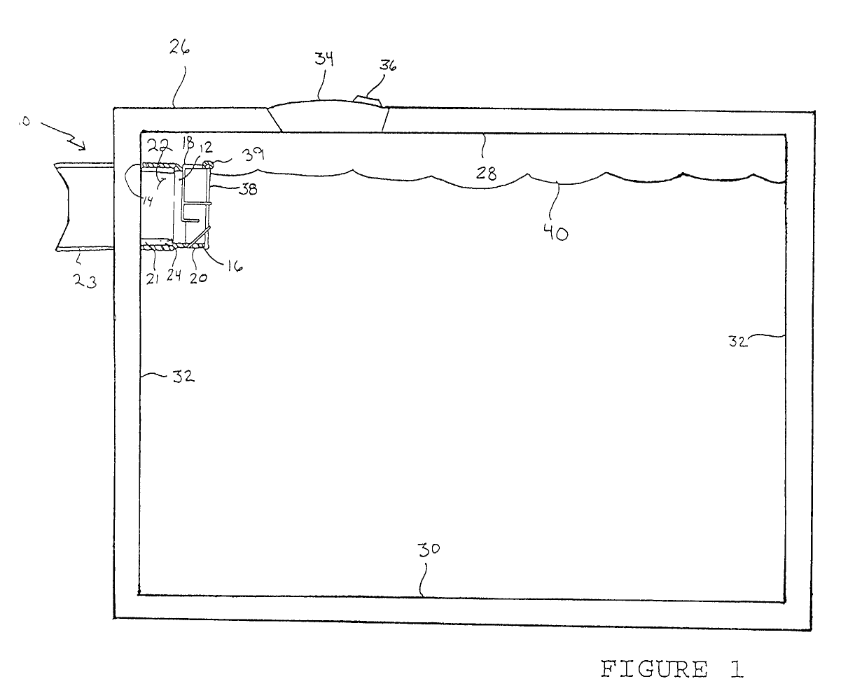

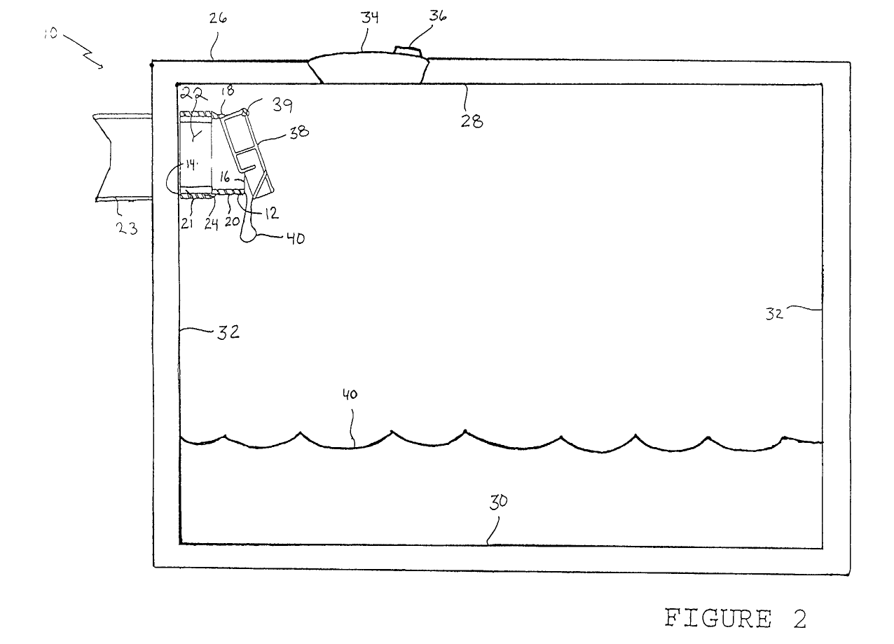

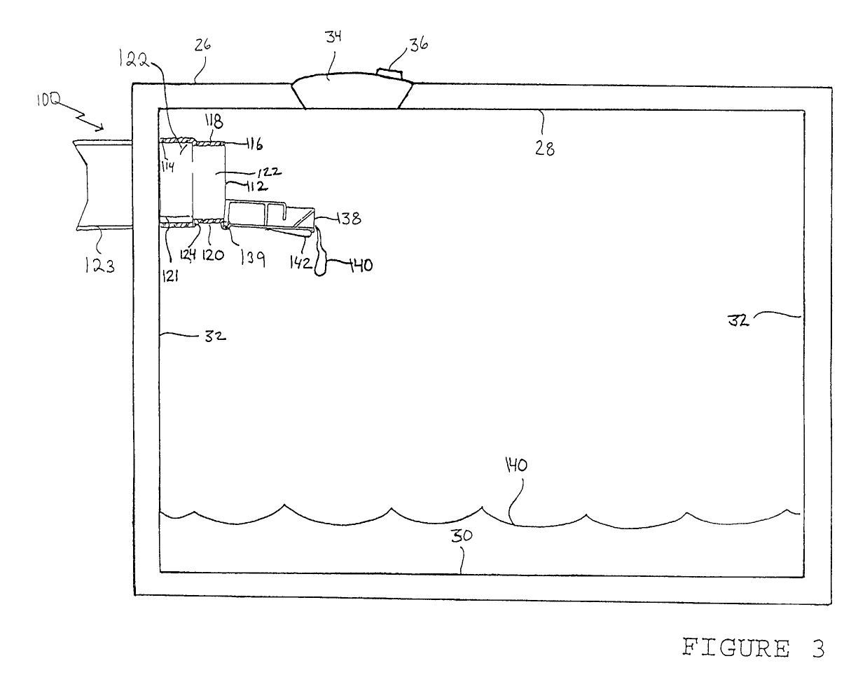

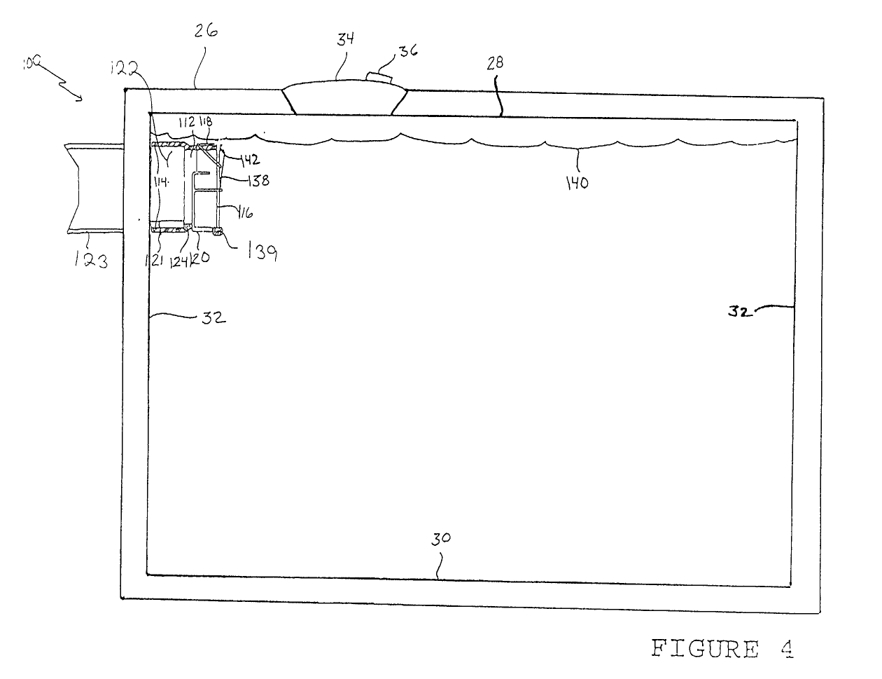

A first embodiment of a backflow valve for an end of a pipe, generally identified by reference numeral 10, will be described with reference to FIGS. 1 and 2. A second embodiment of a backflow valve for an end of a pipe, generally identified by reference numeral 100, will be described with reference to FIGS. 3 and 4.

Referring to FIG. 1, backflow valve 10 consists of a cylindrical body 12 having a first end 14, a second end 16, a top 18, and a bottom 20. A flow passage 22 extends between first end 14 and second end 16. First end 14 has a coupling adapted to mate with an end 21 of a pipe 23. In the illustrated embodiment, coupling is in the form of a collar 24 that slides over end 21 of pipe 23. Backflow valve 10 is illustrated in a typical environment, positioned in a septic tank 26. Septic tank 26 has a top 28, a bottom 30, and opposed walls 32. An inspection port 34 with a lifting handle 36 is located at top 28 of septic tank 26. A closure gate 38 is provided which is pivotally mounted to top 18 of body 12 to normally assume the closed position by force of gravity as illustrated in FIG. 1. Referring to FIG. 2, closure gate 38 is pivoted to the open position by the flow of liquid 40 through body 12. Referring to FIGS. 1 and 2, closure gate 38 is pivotally mounted to second end 16 of body 12 for movement about a substantially horizontal axis defined by hinge 39 between an open position permitting flow in one direction through flow passage 22 as illustrated in FIG. 2 and a closed position blocking flow passage 22 to prevent a reversal of flow as illustrated in FIG. 1.

The use and operation of backflow valve 10 will now be described with reference to FIGS. 1 and 2. Adhesive is applied to collar 24. Collar 24 is then slid over end 21 of pipe 23 and the adhesive is allowed to set. Care is taken to ensure that hinge 39 is positioned on top 18 of body 12 in a substantially horizontal orientation. In this orientation, closure gate 38 falls by force of gravity into the closed position, as illustrated in FIG. 1. When closure gate 38 is in the closed position, no liquid can enter into end 21 of pipe 23. When liquid flows through flow passage 22 from first end 14 to second end 16, closure gate 38 pivots out of the way in response to the passage of liquid as illustrated in FIG. 2.

A second embodiment of a backflow valve, backflow valve 100, is intended to illustrate that alternative closure configurations can be used in accordance with the teachings of the invention. Referring to FIG. 3, backflow valve 100 consists of a cylindrical body 112 having a first end 114, a second end 116, a top 118, and a bottom 120. A flow passage 122 extends between first end 114 and second end 116. First end 114 has a coupling adapted to mate with an end 121 of a pipe 123. In the illustrated embodiment, coupling is in the form of a collar 124 that slides over end 121 of pipe 123. Backflow valve 100 is illustrated in a typical environment, positioned in a septic tank 26. Septic tank 26 has a top 28, a bottom 30, and opposed walls 32. An inspection port 34 with a lifting handle 36 is located at top 28 of septic tank 26. A closure gate 138 is provided which is pivotally mounted to bottom 120 of body 112 to normally assume the open position by force of gravity as illustrated in FIG. 3. Referring to FIG. 4, closure gate 138 has a built in float 142. As liquid rises in septic tank 26, closure gate 138 is carried by the rising liquid to the closed position illustrated in FIG. 4. Referring to FIGS. 3 and 4, closure gate 138 is pivotally mounted to second end 116 of body 112 for movement about a substantially horizontal axis defined by hinge 139 between an open position permitting flow in one direction through flow passage 122 as illustrated in FIG. 3 and a closed position blocking flow passage 122 to prevent a reversal of flow as illustrated in FIG. 4.

The use and operation of backflow valve 100 will now be described with reference to FIGS. 3 and 4. Adhesive is applied to collar 124. Collar 124 is then slid over end 121 of pipe 123 and the adhesive is allowed to set. Care is taken to ensure that hinge 139 is positioned on bottom 120 of body 112 in a substantially horizontal orientation. In this orientation, closure gate 138 falls by force of gravity into the open position, as illustrated in FIG. 3. When closure gate 138 is in the open position, liquid 140 passes freely through backflow valve 100 from first end 114 to second end 116. When liquid 140 rises in septic tank 26, closure gate 138 is carried by rising liquid 140 to the closed position as illustrated in FIG. 4.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A backflow valve for an end of a pipe, comprising:
a cylindrical body having a first end, a second end and a flow passage that extends between the first end and the second end;
the first end being securable to an end of a pipe;
a closure gate pivotally mounted to the second end of the body for movement about a substantially horizontal axis between an open position permitting flow in one direction through the flow passage and a closed position blocking the flow passage to prevent a reversal of flow.

2. The backflow valve as defined in claim 1, wherein one of a male coupling and a female coupling is positioned at the first end of the body.

3. The backflow valve as defined in claim 1, wherein the body has a top and a bottom, the closure gate being pivotally mounted to the top of the body to normally assume the closed position by force of gravity, the closure gate being pivoted to the open position by the flow of liquid through the body.

4. The backflow valve as defined in claim 1, wherein the body has a top and a bottom, the closure gate being pivotally mounted to the bottom of the body to normally assume the open position by force of gravity, the closure gate having a float, the rise of liquid floating the closure gate into the closed position.
